(19) United States
(12) Patent Application Publication
(10) Pub. No.: US 2025/0242954 A1
(43) Pub. Date: Jul. 31, 2025

(54) FEEDING APPARATUS, BARRIER SYSTEM AND METHOD

(71) Applicant: Groninger & Co. GmbH, Crailsheim (DE)

(72) Inventors: Denis BORKMANN, Satteldorf (DE); Peter BURKHARDT, Buehlertann (DE)

(21) Appl. No.: 19/184,374

(22) Filed: Apr. 21, 2025

Related U.S. Application Data
(63) Continuation of application No. PCT/EP2023/078870, filed on Oct. 17, 2023.

(30) Foreign Application Priority Data
Oct. 28, 2022 (DE) 10 2022 128 718.1

(51) Int. Cl. B65B 7/28; B25J 21/00; B65G 27/34

(52) U.S. Cl. CPC B65B 7/2807; B25J 21/00; B65G 27/34

(57) ABSTRACT

A feeding apparatus for feeding closure elements into an environment with restricted access, such as an isolator, wherein the feeding apparatus comprises a feeding unit, a first vibrating plate and a second vibrating plate. The feeding unit is configured to feed the closure elements onto the first vibrating plate, the first vibrating plate is configured to convey the closure elements, in particular during normal operation, onto the second vibrating plate, and the second vibrating plate is configured to arrange the closure elements on the second vibrating plate in a defined position, for example, to orient them. There is also disclosed a barrier system and a method for feeding closure elements into an environment with restricted access, such as an isolator.

### CROSS-REFERENCE TO RELATED APPLICATIONS

This is a Continuation application of International patent application PCT/EP2023/078870, filed Oct. 17, 2023, which claims the priority of German patent application DE 10 2022 128 718.1, filed Oct. 28, 2022. Both application PCT/EP2023/078870 and DE 10 2022 128 718.1 are herewith incorporated by reference in their entireties.

### FIELD

The present invention generally relates to a feeding apparatus for feeding closure elements into an isolator, to a barrier system, to an isolator system, and to a method for feeding closure elements into an isolator.

### BACKGROUND

A barrier system is to be understood as a system that provides a physical and aerodynamic barrier, for example by means of excess pressure, between an external environment, for example an external cleanroom environment, and a working process. In particular, a barrier system provides an environment with restricted access in which the working process can be carried out. Various barrier systems are known in the prior art. A barrier system may comprise, for example, an isolator or a barrier with restricted access, a so-called RABS, “Restricted Area Barrier System”. The RABS may be an open RABS or a closed RABS.

The present disclosure primarily relates to aseptic isolators as barrier systems. However, the present disclosure can also be applied in other barrier systems, such as in an open or closed RABS.

The term “isolator” is generally to be understood as a container that is hermetically sealed and gas-tight with respect to the surrounding working area. Within an isolator, a defined atmosphere can be generated for handling sensitive or hazardous products.

In this context, isolators are typically used in biopharmaceutical process engineering, for example as part of a filling system with multiple processing and handling stations, in order to create a high-purity or sterile, i.e. germ-free, environment.

In such filling systems, containers (e.g. vials, carpules, flasks, syringes and/or the like) can be filled with a product (e.g. a pharmaceutical or cosmetic product, in particular a liquid or a powder) and then closed with a closure element (e.g. a stopper or a crimp cap).

For handling the containers and/or the closure elements, one or more handling apparatuses (e.g. handling robots) can be arranged in the isolator. For filling the containers, a filling station can be provided in the isolator. For closing the containers, one or more closing stations (e.g. a stopper placement station and/or a crimping station) can be arranged in the isolator. In a closing station, each container is closed with a closure element after filling. In particular, a stopper can be placed on the container in a stopper placement station. In the crimping station, a crimp cap can be applied (in particular crimped) onto the container.

Feeding apparatuses can be used inside the isolator for introducing or feeding closure elements into the isolator. For example, the closure elements can be provided in a transfer lock or a supply container (e.g. a beta container filled with closure elements) outside the isolator. This supply container can then be coupled from the outside to a port (e.g. an alpha-beta port) of the isolator. The feeding apparatus can comprise a chute or a tube, which can be correspondingly coupled to the port from the inside. The closure elements can then be guided, for example, from the transfer lock into a collection container inside the isolator via the chute or the tube. From the collection container, the closure elements can then be brought, in particular in a singulated or individual manner, to the closing station.

Such feeding apparatuses are known in the prior art.

For example, document DE 10 2021 101 384 B3 discloses a system for transporting sterile free-flowing closure elements from an environment of an isolator into an interior of the isolator, comprising a container for storing a supply quantity of closure elements in the environment of the isolator, an isolator opening, and a collecting device for collecting the closure elements and for providing the closure elements in the interior of the isolator, with a metering apparatus for controlling a target quantity of closure elements to be transported from the container through the isolator opening and into the collecting device.

Furthermore, document EP 3 581 339 B1 discloses a transfer system for a sealed enclosure, wherein the sealed enclosure defines a first closed volume and comprises at least one sealed connection device which is intended to connect the first closed volume to a second closed volume, wherein the transfer system is intended to be arranged in the enclosure, wherein the transfer system comprises at least one arm which is intended to be rotatably mounted to a wall of the sealed enclosure via a first rotary joint which has a first axis of rotation, wherein the transfer system comprises a chute, wherein the chute has a docking edge and a discharge edge, wherein the docking edge is designed to cooperate with the sealed connection device, wherein the transfer system comprises a second rotary joint between the arm and the chute, the second rotary joint having a second axis of rotation.

Furthermore, document WO 2021/214809 A1 discloses an apparatus for filling containers with a powdery material, comprising a feeding station which is arranged for feeding a plurality of the containers; a filling station which is arranged downstream of the feeding station and comprises a measuring assembly which is configured to fill each container with a metered quantity of powdery material; a closing station which is arranged downstream of the filling station; at least one handling assembly which is movable to transport at least one container from one station to a subsequent station.

Furthermore, document EP 2 801 828 A1 discloses a method for closing vessels containing biological samples. The method comprises providing a cap supply with multiple caps for the vessels inside compartments in a predefined geometric arrangement. The cap supply is introduced via an interface into a pre-analytical system comprising a housing. For this purpose, it is docked reversibly to a feeding apparatus in order to introduce the cap supply into the pre-analytical system and to remove it from there. Subsequently, a cap is removed from the supply by a robotic manipulator and transported to a workstation holding the vessels. A vessel is then closed using the manipulator. The steps from introducing the cap supply into the pre-analytical system to closing a vessel are then repeated a certain number of times or until all caps from the supply have been removed. Finally, the cap supply is retrieved from the pre-analytical system.

However, the known feeding apparatuses still leave room for improvement, in particular, with regard to the provision of the closure elements.

### SUMMARY

It is an object of the present disclosure to provide an improved feeding apparatus for feeding closure elements into an isolator, in particular in which the provision of the closure elements is improved.

Furthermore, it is an object of the present disclosure to provide an improved isolator system. Furthermore, it is an object of the present disclosure to provide an improved method for feeding closure elements into an isolator.

According to a first aspect, a feeding apparatus for feeding closure elements into an environment with restricted access, in particular into an isolator, is provided, wherein the feeding apparatus comprises a feeding unit, a first vibrating plate and a second vibrating plate, wherein the feeding unit is configured to feed the closure elements onto the first vibrating plate, wherein the first vibrating plate is configured to convey the closure elements, in particular during normal operation, onto the second vibrating plate, and wherein the second vibrating plate is configured to arrange the closure elements on the second vibrating plate in a defined position, in particular to orient them.

According to a second aspect, a barrier system is provided, wherein the barrier system comprises an environment with restricted access, in particular an isolator, and the feeding apparatus according to the first aspect of the disclosure, wherein the feeding apparatus is arranged within the environment with restricted access, in particular within the isolator. The barrier system may in particular be an isolator system, wherein the environment with restricted access is an isolator. Alternatively, the barrier system may also be an open or closed RABS.

According to a third aspect, a method for feeding closure elements into an environment with restricted access, in particular into an isolator, is provided, wherein a feeding apparatus is arranged within the environment with restricted access, in particular within the isolator, wherein the feeding apparatus comprises a feeding unit, a first vibrating plate and a second vibrating plate, wherein the method further comprises the following steps:
feeding the closure elements by means of the feeding unit onto the first vibrating plate;
conveying the closure elements, in particular during normal operation, by means of the first vibrating plate onto the second vibrating plate; and
arranging, in particular orienting, the closure elements by means of the second vibrating plate on the second vibrating plate in a defined position.

The feeding apparatus serves to feed closure elements into the isolator. The closure elements may be, for example, stoppers or closure caps, in particular crimp caps. The closure elements may have a height and a diameter. The height of the closure elements may be 5 to 16 mm, preferably 6 mm to 11 mm, in particular 7.5 mm. The diameter may be 5 to 40 mm, preferably 13 mm to 32 mm, in particular 20 mm. For example, the closure elements may be stoppers having a height of 5 mm to 16 mm and a diameter of 5 mm to 32 mm. Alternatively, the closure elements may also be crimp caps having a height of 6 mm and a diameter of 13 mm, or a height of 7.5 mm and a diameter of 20 mm, or a height of 11 mm and a diameter of 32 mm.

The feeding apparatus is preferably arranged inside the isolator. The isolator may comprise an interior. The feeding apparatus may be arranged in the interior. The isolator is preferably an aseptic isolator. An aseptic isolator comprises a high-purity or sterile, i.e. germ-free, environment in the interior.

The isolator is preferably part of a filling system with multiple processing and handling stations. The filling system may be, for example, a system for filling and closing containers with a pharmaceutical or cosmetic substance. The system may in particular comprise a filling station and at least one closing station. In normal operation of the system, the containers are filled in the filling station and closed in the at least one closing station.

At least one closing station may be arranged in the isolator. The closing station may be a stopper placement station or a crimping station. In the closing station, filled containers can be closed with the fed closure elements. For this purpose, the closing station may comprise, for example, a closing apparatus, in particular a stopper placement apparatus or a crimping apparatus, by means of which the containers are closed with the closure elements. The fed closure elements thus serve to close the containers.

Furthermore, a filling station may also be arranged in the isolator, in which the containers can be filled before being closed. In particular, the containers can be filled with the pharmaceutical or cosmetic substance in the filling station. For handling the containers and/or the closure elements, one or more handling apparatuses (e.g. handling robots) may be arranged in the isolator.

The isolator may in particular comprise a transfer system via which the closure elements can be introduced into the isolator. For this purpose, the transfer system may comprise an isolator opening. The isolator opening may be closable by means of a door. A transfer lock can be coupled to the isolator opening from the outside. The closure elements can be arranged in the transfer lock. Preferably, the transfer lock is coupled to the isolator opening with the door closed, and the door is opened only in the coupled state. For example, the transfer system may be configured as a port system, in particular as an alpha-beta port system. The port system may comprise an alpha port integrated into the isolator. The alpha port may comprise the isolator opening and the door. The transfer lock may be configured as a beta port or beta container, which can be coupled to the alpha port. The beta port or beta container may be, for example, a sterile bag or a rigid transport container (e.g. a stainless steel container, a plastic container, or an aluminum container).

The feeding unit serves to feed the closure elements onto the first vibrating plate or to provide them on the first vibrating plate. The feeding unit may be, for example, coupleable to the isolator opening from the inside in order to introduce the closure elements from the transfer lock into the isolator and to feed them to the first vibrating plate

The first vibrating plate and the second vibrating plate are configured to move closure elements. The movement of the closure elements is effected by a movement, in particular a vibrating motion, of the respective vibrating plate. For this purpose, each vibrating plate may comprise a plate and a drive unit. The plate serves as a support for the closure elements. In particular, the closure elements are conveyed or arranged on the plate. The drive unit of the respective vibrating plate is configured to move the plate of the vibrating plate, in particular to vibrate or oscillate it, in order to convey or arrange the closure elements located thereon accordingly. The movement of the respective vibrating plate may be a translational and/or rotational movement. The translational movement may take place in a horizontal and/or vertical direction. The rotational movement may be a rotary motion about one or more axes. The vibrating motion of the vibrating plate may be an oscillating movement.

In normal operation, the first vibrating plate conveys the fed closure elements onto the second vibrating plate. The closure elements are conveyed on the first vibrating plate in a first conveying direction towards the second vibrating plate. In particular, conveying onto the second vibrating plate takes place only during normal operation. The first vibrating plate is preferably configured to convey a number of closure elements (e.g. one, two or three closure caps) onto the second vibrating plate. In particular, the first vibrating plate can convey the closure elements in a metered or singulated manner (e.g. in small quantities) onto the second vibrating plate. The conveying of the closure elements is effected by vibrating the first vibrating plate. In particular, the conveying can be effected by a rotational movement or by a combination of a rotational and a translational movement of the first vibrating plate. For example, the conveying can be effected by a preferably oscillating tilting movement of the first vibrating plate. The first vibrating plate is preferably oriented horizontally and is tilted or inclined from its horizontal position, preferably in an oscillating manner, into the respective conveying direction for conveying. “Oscillating” in this context means that the first vibrating plate is inclined from the horizontal position into the respective conveying direction and back into the horizontal position, preferably repeatedly. As a result, the closure elements are moved in the conveying direction. In normal operation, the oscillating tilting movement takes place in the first conveying direction and is thus directed towards the second vibrating plate.

On the second vibrating plate, each closure element conveyed onto the second vibrating plate is then provided in a defined position. For this purpose, the second vibrating plate is configured to arrange each closure element in this defined position. The defined position may comprise a location and/or an orientation in space. If a closure element on the second vibrating plate is not arranged in the defined position, the second vibrating plate may be configured to change the position of the closure element. The change in position may be effected by vibrating the second vibrating plate. The second vibrating plate is preferably oriented horizontally.

In a preferred embodiment, the defined position may comprise a defined orientation of each closure element in space. The second vibrating plate is then configured to orient each closure element on the second vibrating plate in the defined orientation. Alternatively or additionally, the defined position may also comprise a location (or a specific region) in space, in which case the second vibrating plate is configured to arrange each closure element in the defined location (or the specific region).

The first vibrating plate is preferably arranged adjacent to the second vibrating plate. The first vibrating plate may be arranged higher in the vertical direction than the second vibrating plate. As a result, the closure elements fall from the first vibrating plate onto the second vibrating plate when they are conveyed to the second vibrating plate. The first vibrating plate and the second vibrating plate may each have a circumferential edge. Each vibrating plate may comprise a barrier on the circumferential edge, the barrier extending along the circumferential edge and preferably completely enclosing the vibrating plate. The barrier is a rim of the respective vibrating plate. Each barrier has a height in the vertical direction. The height may be 10 mm to 100 mm, preferably 25 mm to 75 mm, in particular 50 mm. The barrier of the first vibrating plate may comprise a first opening to the second vibrating plate. The first opening is thus arranged on a side of the first vibrating plate facing the second vibrating plate. Through the first opening, the closure elements can be conveyed onto the second vibrating plate.

The principle of closure feeding according to the disclosure is explained once again below. The provision of the closure elements in the isolator takes place via the feeding unit, which can be connected, for example, to a port (in particular an isolator opening) of the isolator. The closure elements are fed via the feeding unit onto the first vibrating plate. The first vibrating plate then conveys a number of the closure elements in normal operation onto the second vibrating plate. On the second vibrating plate, each closure element is intended to be arranged in a defined position. In order to arrange the closure elements in the defined position, the closure elements can be vibrated on the second vibrating plate.

By providing a number of closure elements in a defined position on the second vibrating plate, one of the handling apparatuses arranged in the isolator can then, for example, successively pick up the closure elements (preferably always two at a time) from the second vibrating plate and transfer them to a closing station.

In this way, an improved, in particular, simple and controlled, provision of the closure elements in the isolator is achieved.

In a first refinement of the aspects, the feeding unit may be coupleable to a port system, in particular to an isolator opening of the isolator, in order to feed the closure elements.

Preferably, the feeding unit can be coupled from the inside to an isolator opening of the isolator. A transfer lock can then be coupled to the isolator opening from the outside. The closure elements can then be fed through the isolator opening and via the feeding unit from the transfer lock onto the first vibrating plate. In this way, the closure elements can be easily introduced into the isolator.

In a further refinement of the aspects, the feeding unit may comprise a chute and/or a tube via which the closure elements can be fed onto the first vibrating plate.

In particular, the closure elements can be fed via the tube or the chute from the isolator opening or from the transfer lock onto the first vibrating plate. A first open end of the tube or the chute can be coupleable to the isolator opening. The second open end of the tube or the chute can be arranged at or above the first vibrating plate. When the first end is coupled to the isolator opening, the second end is preferably arranged lower than the first end. As a result, the closure elements can slide along the tube or chute from the isolator opening to the first vibrating plate due to gravity. In this way, the closure elements can be easily introduced into the isolator. The second end can be arranged at a preferably small distance above the first vibrating plate. The distance may be 5 mm to 100 mm, preferably 10 mm to 75 mm, in particular 15 or 35 mm or 63 mm. The distance is preferably greater than a maximum diameter of the closure elements. The distance can in particular be adjustable. In particular, the first vibrating plate can be moved in the vertical direction in order to adjust the distance. In normal operation, the distance is preferably 10 mm to 50 mm, in particular 15 mm to 35 mm. In particular, at the start of normal operation, especially during the initial filling of the tube, the distance may initially be 15 mm. After the start of normal operation, the distance may then be 15 mm to 35 mm. In special operation, in particular for discharging closure elements, the distance may be greater than in normal operation. In particular, the distance in special operation may be 50 mm to 75 mm, in particular 63 mm.

In a further refinement of the aspects, the first vibrating plate may comprise a first surface for conveying the closure elements, wherein the closure elements can be fed onto the first surface and conveyed on the first surface, wherein the first surface is a flat surface.

In other words, the closure elements can be fed onto the first surface of the first vibrating plate and then conveyed on it. The first surface is arranged on a top side of the first vibrating plate in the vertical direction. The flat surface is well suited for conveying the closure elements.

In a further refinement of the aspects, the second vibrating plate may comprise a second surface, wherein the closure elements can be conveyed from the first vibrating plate onto the second surface and can be arranged on the second surface in the defined position, wherein the second surface comprises studs.

In other words, the closure elements can be conveyed onto the second surface of the second vibrating plate and then arranged or oriented thereon in the defined position. The second surface is arranged on a top side of the second vibrating plate in the vertical direction. The second surface is not flat, but comprises studs. The studs are evenly distributed on the second surface. The studs project upwards from the second surface in the vertical direction. Due to the studs, the closure elements come to rest or to a standstill more quickly on the second vibrating plate after they have either been conveyed onto the second vibrating plate or the second vibrating plate has been vibrated to change the position. In particular, closure elements such as caps or stoppers generally have an essentially cylindrical shape and can therefore roll, especially on flat surfaces. The studs now prevent the closure elements from moving, in particular rolling, on the second surface for a long time and thus not coming to a standstill. In this way, the position of the closure elements can be determined more quickly by means of a camera system, because the determination of the position is only possible once the closure elements are not moving. Furthermore, a handling apparatus in the isolator can also grasp the closure elements more quickly and transfer them to the closing station, because gripping is only possible once the closure elements are not moving and are arranged in the defined position. The studs may have a height in the vertical direction and a diameter in the horizontal direction. The height may be 0.5 mm to 3 mm, preferably 0.75 mm to 2 mm, in particular 1 mm. The diameter may in particular be 1 mm to 4 mm, preferably 1.4 mm to 2.5 mm, in particular 1.7 mm. In an alternative refinement, the second surface may also be flat, in particular without studs. The refinement of the second surface with studs is particularly suitable when the closure elements are closure caps, in particular crimp caps. The refinement of the second surface without studs may be used when the closure elements are stoppers.

In a further refinement of the aspects, the feeding device may further comprise a control unit configured to control the first vibrating plate and the second vibrating plate.

The first vibrating plate can be controlled in such a way that the closure elements, preferably a number of closure elements, are conveyed onto the second vibrating plate. The second vibrating plate can be controlled in such a way that the closure elements are arranged or oriented in a defined position on the second vibrating plate. In this way, the feeding of the closure elements as well as the provision of a number of closure elements can be controlled. The control unit may further be configured to control the handling apparatus that transfers the closure elements to the closing station within the isolator. Alternatively, the isolator system may also comprise a separate control unit for this purpose, which controls the handling apparatus.

In a further refinement of the aspects, the feeding apparatus may further comprise a camera system which is configured to capture at least one image of the closure elements on the second vibrating plate, wherein the camera system and/or the control unit are configured to determine the position of the closure elements on the second vibrating plate on the basis of the at least one captured image.

For this purpose, the camera system may comprise one or more cameras. Based on the at least one captured image, the position (in particular location and/or orientation) of each closure element on the second vibrating plate can then be determined. The determination can be carried out by the control unit or by the camera system. Based on the determined position, the first vibrating plate and/or the second vibrating plate and/or the handling apparatus can then be controlled accordingly to convey closure elements onto the second vibrating plate and/or to arrange them in a defined position and/or to transfer them to the closing station.

In a further refinement of the aspects, the control unit can be configured to control the first vibrating plate based on the determined position of the closure elements in such a way that a number of closure elements are conveyed onto the second vibrating plate.

In this way, the closure elements can be conveyed onto the second vibrating plate in a metered or singulated or individual manner. If only a small number of closure elements is arranged on the second vibrating plate, the second vibrating plate can arrange them more easily and quickly in the defined position. In addition, the closure elements can then also be grasped more easily and quickly by means of the handling apparatus.

In a further refinement of the aspects, the control unit may be configured to control the second vibrating plate on the basis of the determined position of the closure elements in such a way that at least one of the closure elements is arranged in the defined position.

If the determined position of a closure element does not correspond to the defined position, the second vibrating plate can, for example, be controlled (or vibrated) in such a way that the position of the closure element changes. In doing so, the closure elements are preferably not “specifically” brought into the defined position by vibrating the second vibrating plate. Vibrating changes the position of all closure elements on the second vibrating plate, whereby some closure elements may return to the correct position. In particular, the second vibrating plate can be vibrated until at least a certain number, for example one or two, of the closure elements are arranged in the defined position. In this way, the closure elements can gradually be arranged in the defined position on the second vibrating plate. The intensity, duration and direction of the movement (vibration) of the second vibrating plate can be determined on the basis of the determined position of the closure elements.

In a further refinement of the aspects, the feeding apparatus may further comprise a discharge apparatus for discharging closure elements.

In particular, the discharge apparatus may be configured to discharge the closure elements fed onto the first vibrating plate during special operation. Special operation of the system occurs when the system is not operating in normal mode. A special operation may occur, for example, when contamination occurs in the isolator or when a handling apparatus or a process station within the isolator is defective. In this case, the system can no longer continue to operate as intended, i.e. the containers should no longer be filled or closed. In special operation, the fed closure elements are therefore discharged by means of the discharge apparatus. In special operation, particularly in the event of contamination, it may also be necessary to close isolator openings. For this purpose, the feeding unit must first be decoupled from the isolator opening. However, this is not possible as long as there are still closure elements in the feeding unit. By discharging the closure elements fed onto the first vibrating plate during special operation, all closure elements can thus be successively fed from the feeding unit onto the first vibrating plate and then discharged. In this way, the feeding unit can be emptied and then decoupled from the isolator opening.

In a further refinement of the aspects, the discharge apparatus may comprise a collection container for collecting discharged closure elements.

The collection container serves to collect the discharged closure elements. In particular, the closure elements are discharged from the first vibrating plate into the collection container during special operation.

In a further refinement of the aspects, the first vibrating plate may be configured to convey the closure elements, in particular during special operation, to the discharge apparatus, in particular wherein the control unit is configured to control the first vibrating plate, in particular during special operation, in such a way that the first vibrating plate conveys the closure elements to the discharge apparatus.

In this way, the closure elements can be conveyed directly from the first vibrating plate to the discharge apparatus, in particular to the collection container, in order to discharge them there, in particular to collect them. The barrier of the first vibrating plate may comprise a second opening to the discharge apparatus, in particular to the collection container. The second opening is thus arranged on a side of the first vibrating plate facing the discharge apparatus, in particular the collection container. Through the second opening, the closure elements can thus be conveyed to the discharge apparatus, in particular into the collection container. In normal operation, the first vibrating plate conveys the closure elements in the first conveying direction through the first opening to the second vibrating plate. In special operation, the first vibrating plate conveys the closure elements in a second conveying direction through the second opening to the discharge apparatus, in particular into the collection container. In particular, the first opening may be open in normal operation and closed in special operation, whereas the second opening may be closed in normal operation and open in special operation. This makes it possible for the closure elements to be conveyed only to the second vibrating plate in normal operation and only to the discharge apparatus in special operation.

In a further refinement of the aspects, the second vibrating plate may be configured to convey the closure elements, in particular during special operation, to the discharge apparatus, in particular wherein the control unit is configured to control the second vibrating plate, in particular during special operation, in such a way that the second vibrating plate conveys the closure elements to the discharge apparatus.

To convey the closure elements to the discharge apparatus, the second vibrating plate, like the first vibrating plate, can be vibrated. In this way, the closure elements can be conveyed from the second vibrating plate to the discharge apparatus, in particular to the collection container, in order to discharge them there, in particular to collect them.

In a further refinement of the aspects, the second vibrating plate and the discharge apparatus may be arranged on opposite sides of the first vibrating plate.

The first opening and the second opening are then arranged on opposite sides of the first vibrating plate. In this case, the first conveying direction and the second conveying direction are opposite to one another. In other words, in this refinement, the closure elements are conveyed in opposite conveying directions during normal operation and special operation.

In an alternative refinement of the aspects, the second vibrating plate and the discharge apparatus may be arranged on the same side of the first vibrating plate or in the same edge region of the first vibrating plate.

The first opening and the second opening are then arranged accordingly on the same side of the first vibrating plate and/or in the same edge region of the first vibrating plate. In particular, the first opening and the second opening may be arranged adjacent to one another at the edge of the vibrating plate. The edge region may be, for example, a corner region where two sides of the vibrating plate meet, with the two openings being arranged on these two sides in the corner region. In this refinement, the first conveying direction and the second conveying direction run essentially parallel to each other. In other words, in this refinement, the closure elements can be conveyed in the same conveying direction in both normal operation and special operation. This simplifies the control and operation of the first vibrating plate.

In a further refinement of the aspects, the first vibrating plate may be movable relative to the second vibrating plate, the control unit being configured to control the movement of the first vibrating plate relative to the second vibrating plate, in particular during special operation, in such a way that the first vibrating plate is lowered relative to the second vibrating plate.

In particular, the first vibrating plate is movable in a vertical direction relative to the second vibrating plate. For this purpose, the drive unit of the first and/or second vibrating plate may be configured to move the first vibrating plate or the second vibrating plate in the vertical direction. In particular, the relative movement is controlled by the control unit in such a way that the first vibrating plate is arranged in a raised position during normal operation and in a lowered position during special operation. The barrier of the second vibrating plate may comprise a first section and a second section. The first section may be arranged in such a way that it closes the first opening in the lowered position. The second section may be arranged in such a way that it closes the second opening in the raised position. This ensures that the first opening is open during normal operation and closed during special operation, whereas the second opening is closed during normal operation and open during special operation. In this way, the closure elements can be conveyed only to the second vibrating plate in normal operation and only to the discharge apparatus in special operation. Alternatively, movable flaps may also be arranged at the first opening and at the second opening, which can close the respective opening so that only the first opening is open in normal operation and only the second opening is open in special operation.

In a further refinement of the isolator system, the isolator system may comprise a closing station for closing containers with the fed closure elements and a handling apparatus for transferring the closure elements from the second vibrating plate to the closing station.

The closing station and the handling apparatus are arranged within the isolator. In particular, the isolator system may comprise a plurality of handling apparatuses, with at least one of these handling apparatuses being configured to transfer the closure elements from the second vibrating plate to the closing station. Preferably, the handling apparatus can grip closure elements that are arranged on the second vibrating plate in the defined position individually or in pairs and transfer them to the closing station. The control unit of the feeding apparatus or a separate control unit of the isolator system may be configured to control the handling apparatus accordingly. In particular, the handling apparatus can be controlled on the basis of the position determined by means of the camera system in order to transfer the closure elements accordingly to the closing station.

In a further refinement of the method, the feeding apparatus may further comprise a discharge apparatus for discharging closure elements, wherein the method further comprises the following step:
conveying the closure elements, in particular during special operation, by means of the first vibrating plate to a discharge apparatus.

As previously explained, the closure elements can thus be conveyed directly from the first vibrating plate to the discharge apparatus, in particular to the collection container, in order to discharge them there, in particular to collect them.

In a further refinement of the aspects, the method may further comprise the following step:
lowering the first vibrating plate relative to the second vibrating plate, in particular during special operation.

In particular, the first vibrating plate is movable in a vertical direction relative to the second vibrating plate. For this purpose, the drive unit of the first and/or second vibrating plate may be configured to move the first vibrating plate or the second vibrating plate in the vertical direction. In particular, the relative movement is controlled by the control unit in such a way that the first vibrating plate is arranged in a raised position during normal operation and in a lowered position during special operation. The barrier of the second vibrating plate may comprise a first section and a second section. The first section may be arranged such that it closes the first opening in the lowered position. The second section may be arranged such that it closes the second opening in the raised position. This ensures that the first opening is open during normal operation and closed during special operation, whereas the second opening is closed during normal operation and open during special operation. In this way, the closure elements can be conveyed only to the second vibrating plate in normal operation and only to the discharge apparatus in special operation.

It is understood that the above-mentioned and the features still to be explained below are not only usable in the respectively indicated combination but also in other combinations or individually without leaving the scope of the present invention.

### DRAWINGS

Exemplary embodiments of the disclosure are illustrated in the drawings and explained in more detail in the following description. They show:

FIG. 1 an isometric view of a first embodiment of an isolator system;

FIG. 2 an isometric view of a first embodiment of a feeding apparatus;

FIG. 3 an isometric view of a feeding unit of the feeding apparatus from FIG. 2 in the coupled state;

FIG. 4 an isometric view of a feeding unit of the feeding apparatus from FIG. 2 in the decoupled state;

FIG. 5 an isometric view of a first vibrating plate of the feeding apparatus from FIG. 2;

FIG. 6 a top view of an upper side of the first vibrating plate from FIG. 5;

FIG. 7 an isometric view of a second vibrating plate of the feeding apparatus from FIG. 2;

FIG. 8 a top view of an upper side of the first vibrating plate from FIG. 7;

FIG. 9 an isometric view of the arrangement of the vibrating plates of the feeding apparatus from FIG. 2;

FIG. 10 an isometric view of a second embodiment of a feeding apparatus;

FIG. 11 an isometric view of a first vibrating plate of the feeding apparatus from FIG. 10;

FIG. 12 a top view of an upper side of the first vibrating plate from FIG. 11;

FIG. 13 an isometric view of a second vibrating plate of the feeding apparatus from FIG. 10;

FIG. 14 a top view of an upper side of the first vibrating plate from FIG. 13;

FIG. 15 an isometric view of the arrangement of the vibrating plates of the feeding apparatus from FIG. 10;

FIG. 16 an isometric view of the arrangement of the first vibrating plate of the feeding apparatus from FIG. 10 in a lowered position;

FIG. 17 an isometric view of the arrangement of the first vibrating plate of the feeding apparatus from FIG. 10 in a raised position; and

FIG. 18 a schematic view of an embodiment of a method for feeding closure elements into an isolator.

### DETAILED DESCRIPTION

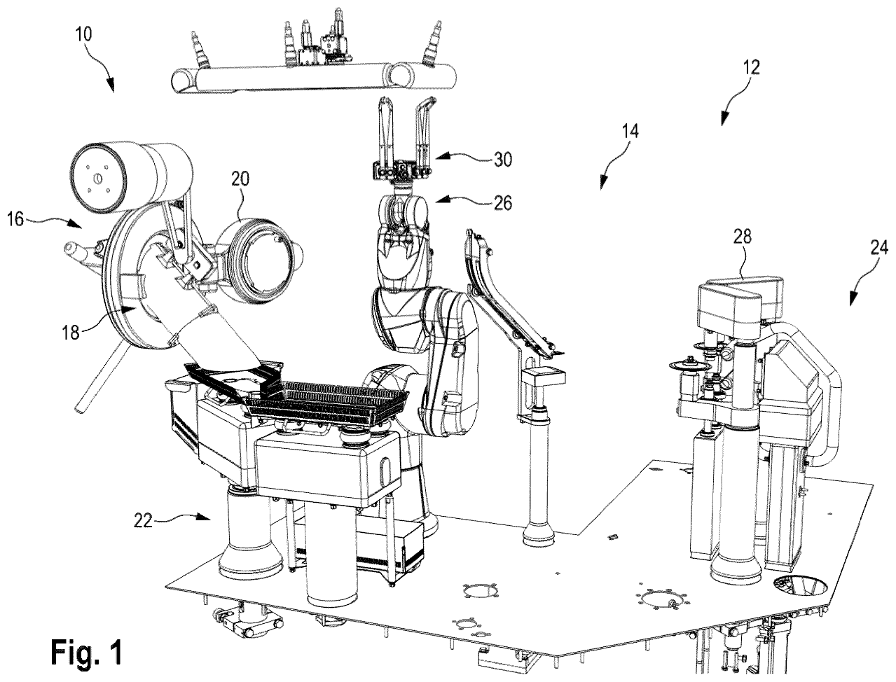

FIG. 1 shows an embodiment of an isolator system as a barrier system, designated in its entirety with reference numeral 10.

The isolator system 10 comprises an isolator 12. The isolator 12 comprises an interior space 14. The isolator 12 further comprises a transfer system 16. The transfer system 16 may be configured as an alpha-beta port system. The transfer system 16 comprises an isolator opening 18 and an isolator door 20. These form an alpha port. The isolator opening 18 is arranged on a wall of the isolator 12 which separates the interior space 14 from an external environment. The isolator door 20 is arranged at the isolator opening 18. The isolator door 20 is rotatably mounted on the wall of the isolator 12. The isolator door 20 can be used to open or close the isolator opening 18. From the outside, a (not shown) transfer lock can be coupled to the isolator opening 18. The transfer lock may be configured as a beta container or beta port.

The isolator system 10 comprises, in the interior space 14 of the isolator 12, a feeding apparatus 22, a closing station 24, and one or more handling apparatuses 26. The isolator system 10 may further comprise a (not shown) filling station. The feeding apparatus 22 serves to feed closure elements into the isolator 12. The closure elements may be provided outside the isolator in a transfer lock, in particular in a beta container, and then introduced into the isolator 12 through the isolator opening 18 and the feeding apparatus 22.

In the closing station 24, containers filled with a product are sealed with the fed closure elements. For closing the containers, the closing station 24 comprises a closing apparatus 28. The closing apparatus 28 may be a crimping apparatus with which crimp caps can be applied to the containers as closure elements.

The one or more handling apparatuses serve to handle the closure elements and/or the containers in the isolator 12. The closure elements can be handled by means of the handling apparatus 26. In particular, the handling apparatus 26 can transfer closure elements fed by the feeding apparatus to the closing station. The handling apparatus 26 comprises an end effector 30. The end effector may comprise, for example, one or more grippers by means of which closure elements and/or containers can be gripped (i.e., picked up and held) for transfer.

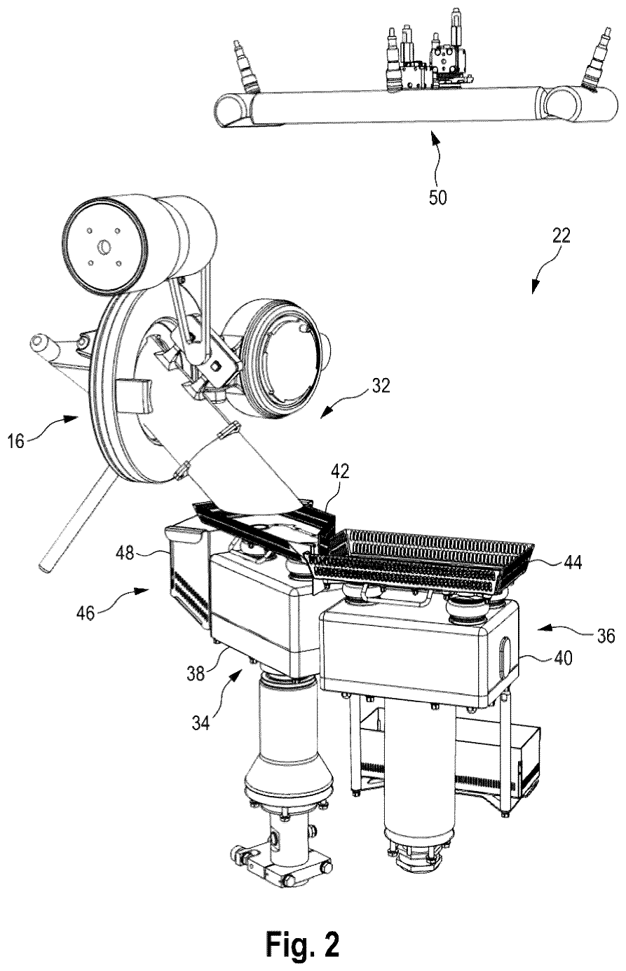

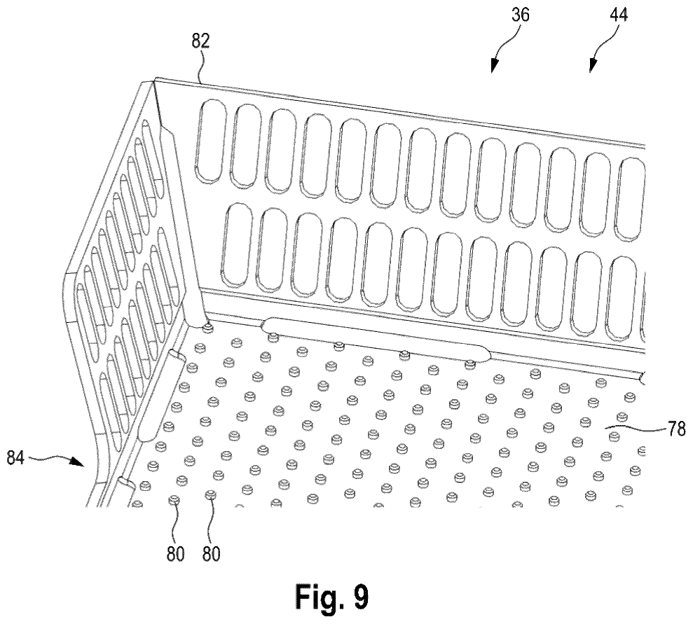

FIGS. 2 to 10 show a first embodiment of a feeding apparatus, designated in its entirety with reference numeral 22. The feeding apparatus of the isolator system 10 may be designed in accordance with the feeding apparatus 22 of the first embodiment. In FIG. 2, the structure of the feeding apparatus 22 is shown in its entirety. The feeding apparatus 22 comprises a feeding unit 32, a first vibrating plate 34, and a second vibrating plate 36.

The feeding unit 32 serves to feed the closure elements from the isolator opening 18 onto the first vibrating plate 34. The feeding unit 32 may, for example, be coupleable to the isolator opening 18 from the inside. In particular, closure elements can be introduced into the isolator 12 from a transfer lock through the isolator opening 18 and the feeding unit 32 and fed to the first vibrating plate 34 by means of the feeding unit 32.

The first vibrating plate 34 is configured to convey the closure elements onto the second vibrating plate 36 during normal operation. The closure elements are conveyed on the first vibrating plate 34 in a first conveying direction toward the second vibrating plate 36. The first vibrating plate 34 comprises a first drive unit 38 and a first plate 42. The first plate 42 serves as a support surface for the closure elements. In particular, the closure elements can be fed onto the first plate 42 and conveyed thereon. The first drive unit 38 is configured to move the first plate 42. In particular, the first drive unit 38 is configured to tilt and vibrate the first plate 42. The conveying of the closure elements during normal operation can be carried out by vibrating the plate 42.

The second vibrating plate 36 is configured to arrange the closure elements on the second vibrating plate 36 in a defined position during normal operation, in particular to orient them. The second vibrating plate 36 comprises a second drive unit 40 and a second plate 44. The second plate 44 serves as a support for the closure elements. In particular, the closure elements can be fed onto the second plate 44 and conveyed thereon. The second drive unit 40 is configured to move the second plate 44. In particular, the second drive unit 40 is configured to vibrate the second plate 44. The arranging or orienting of the closure elements in the defined position can be carried out by vibrating the plate 44. As a result, the closure elements are provided on the second vibrating plate 36 in the defined position. Closure elements provided in this defined position can then be picked up by the handling apparatus 26 and transferred to the closing station.

The feeding apparatus 22 may further comprise a discharge apparatus 46. The discharge apparatus 46 and the second vibrating plate 36 are arranged on opposite sides of the first vibrating plate 34. The discharge apparatus 46 serves to discharge closure elements, in particular during special operation. The discharge apparatus 46 comprises a collection container 48. The collection container 48 serves to receive or collect discharged closure elements. The first vibrating plate 34 is configured to convey the closure elements to the discharge apparatus 46, in particular into the collection container 48, during special operation. The closure elements are conveyed on the first vibrating plate 34 in a second conveying direction toward the discharge apparatus 46. The conveying of the closure elements during special operation can be carried out by vibrating the plate 42.

The feeding apparatus 22 may further comprise a camera system 50. The camera system 50 is preferably arranged above the second vibrating plate 36. For example, the camera system 50 can be mounted on a ceiling of the isolator. The camera system 50 is configured to capture at least one image of the closure elements on the second vibrating plate 36. The camera system 50 may comprise one or more cameras for this purpose. The camera system 50 may also comprise an illumination unit by means of which at least the area to be captured during image acquisition is illuminated. On the basis of the at least one captured image, the position of each closure element on the second vibrating plate 36, in particular its location and/or orientation on the second vibrating plate 36, can be determined. In particular, the number of closure elements located on the second vibrating plate 36 is also determined.

The feeding apparatus 22 may further comprise a (not shown) control apparatus. The control apparatus is configured to control the vibrating plates 34, 36 (in particular the drive units 38, 40). The first vibrating plate 34 can be controlled in such a way that the closure elements, preferably a number of closure elements, are conveyed to the second vibrating plate 36 during normal operation and the closure elements are conveyed to the discharge apparatus 46 during special operation. The second vibrating plate 36 can be controlled in such a way that the closure elements are arranged or oriented in a defined position on the second vibrating plate 36. In particular, the control apparatus can control the drive units 38, 40 in order to move the plates of the vibrating plates 34, 36 accordingly, in particular to vibrate and/or tilt them.

The control apparatus can be configured to control the camera system 50. In particular, the control apparatus can control the image acquisition of the camera system to capture the at least one image. The control apparatus may in particular be configured to determine the position of the closure elements on the second vibrating plate 36 based on the at least one captured image. Based on the determined position, the first vibrating plate 34 and/or the second vibrating plate 36 and/or the handling apparatus 26 can then be controlled accordingly.

In particular, the control apparatus may be configured to control the first vibrating plate 34 (in particular the first drive unit 38) based on the determined position of the closure elements in such a way that a number of closure elements is conveyed onto the second vibrating plate. Furthermore, the control apparatus may be configured to control the second vibrating plate 36 (in particular the second drive unit 40) based on the determined position of the closure elements in such a way that the closure elements are arranged or oriented in the defined position. Furthermore, the control apparatus may be configured to control the handling apparatus 26 in such a way that closure elements arranged in the defined position on the second vibrating plate 36 are transferred to the closing station 24.

For this purpose, the control apparatus may, for example, comprise various sub-units, each performing control of a component and/or processing of data. For example, the control apparatus may comprise a control unit which controls the vibrating plates 34, 36 (in particular the drive units 38, 40). The control unit can also control the camera system 50 and/or the handling apparatus 26. For controlling the respective components, the control unit can, for example, send control commands to these components. Furthermore, the control apparatus can comprise a data processing unit which is configured to carry out the evaluation of images captured by the camera system. The data processing unit can, for example, determine the position of closure elements on the second vibrating plate based on the captured images.

The control apparatus may be connected to or comprise a non-volatile data memory in which a computer program is stored. In some embodiments, the control apparatus is a general-purpose computer, such as a commercially available personal computer running Windows®, Linux, or macOS, and the computer program from the memory comprises program code designed and configured to implement control and determination steps. In an alternative embodiment, the control apparatus is a logic circuit, such as a Field Programmable Gate Array (FPGA), an Application-Specific Integrated Circuit (ASIC), a microcontroller, or any other suitable programmable electrical circuit. In this circuit, the control and determination steps can be implemented with the logic circuit. To implement the control and determination steps in the logic circuit, any suitable programming language or hardware description language may be used, such as C, VHDL, and the like.

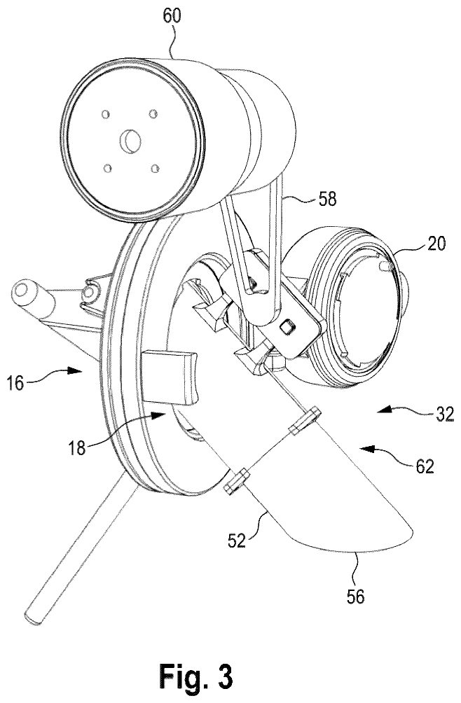

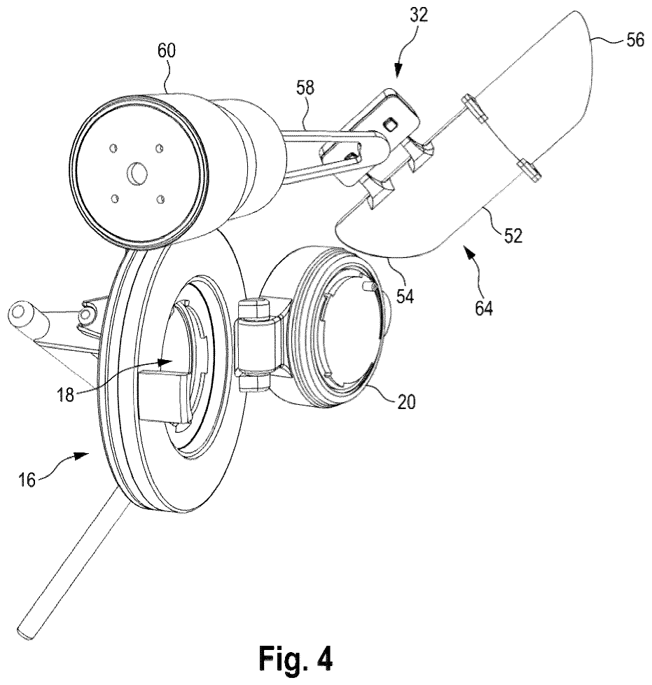

FIGS. 3 and 4 show the structure of the feeding unit 32. The feeding unit comprises a tube 52. The tube 52 has a first open end 54 and a second open end 56. The first end 54 is coupleable to the isolator opening 18. The feeding unit 32 further comprises a pivot mechanism by means of which the feeding unit 32 can be coupled to or decoupled from the isolator opening 18. For this purpose, the feeding unit 32 comprises an arm 58 and a motor 60. The tube 52 is pivotably mounted on the wall of the isolator 12 via the arm 58, in particular above the isolator opening 18. The arm 58 is rigidly connected to the tube 52. The arm is pivotably mounted on the wall of the isolator 12. The motor 60 is configured to move the arm 58 (and thus also the tube 52) relative to the isolator opening 18 between a coupled state 62 and a decoupled state 64, in particular to displace, in particular to pivot.

In FIG. 3, the feeding unit 32 is shown in the coupled state 62. In the coupled state 62, the first end 52 is coupled to the isolator opening 18. In the coupled state 62, the second end 54 is arranged at a distance above the first vibrating plate 34. In the coupled state 62, the first end 54 is preferably arranged higher in the vertical direction than the second end 56.

In FIG. 4, the feeding unit 32 is shown in the decoupled state 64. In the decoupled state 64, the first end 52 is not coupled to the isolator opening 18. In particular, the tube 52 is pivoted away from the isolator opening 18 in the decoupled state to such an extent that the isolator door 20 can close the isolator opening.

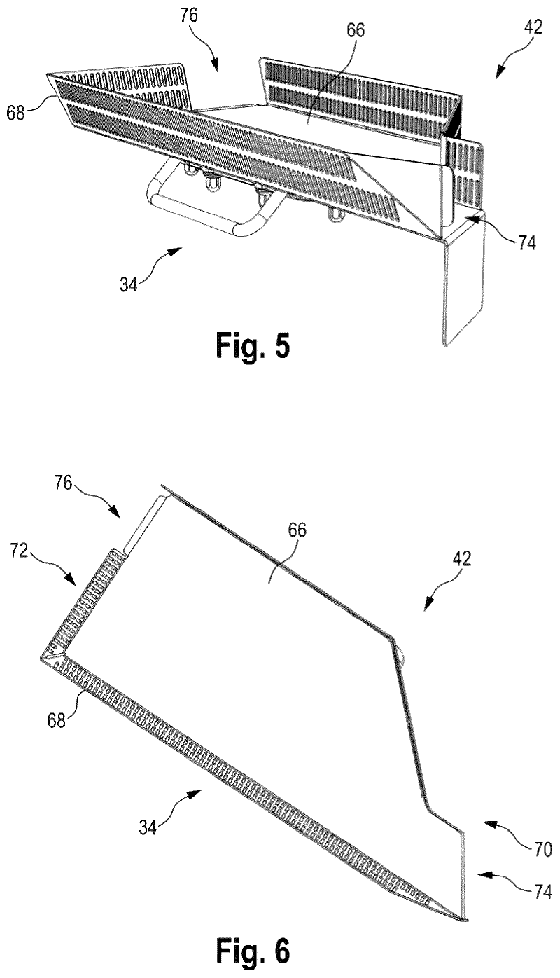

FIGS. 5 and 6 show the structure of the first vibrating plate 34, with the drive unit 38 omitted for better illustration of the plate.

The first vibrating plate 34 comprises (in particular on an upper side of the plate 42) a first surface 66 as a support for the closure elements. The closure elements can in particular be fed onto the first surface 66 and conveyed on the first surface 66. The first surface is a flat surface. The first vibrating plate 34 comprises a first side 70 and a second side 72. The first side 70 is facing the second vibrating plate 36. The second side 72 is facing the discharge apparatus 46. The sides 70, 72 are arranged opposite to each other.

The first vibrating plate 34 (in particular the plate 42) comprises a peripheral edge. The first vibrating plate 34 comprises a barrier 68 on the peripheral edge. The barrier 68 extends along the peripheral edge and preferably completely encloses the first vibrating plate 34. The barrier 68 projects upward in the vertical direction from the first surface 66. The barrier 68 comprises, on the first side 70, a first opening 74 toward the second vibrating plate 36. The barrier 68 comprises, on the second side 72, a second opening 76 toward the discharge apparatus 46. Through the first opening 74, the closure elements can be conveyed onto the second vibrating plate 36. Through the second opening 76, the closure elements can be conveyed to the discharge apparatus 46, in particular into the collection container 50.

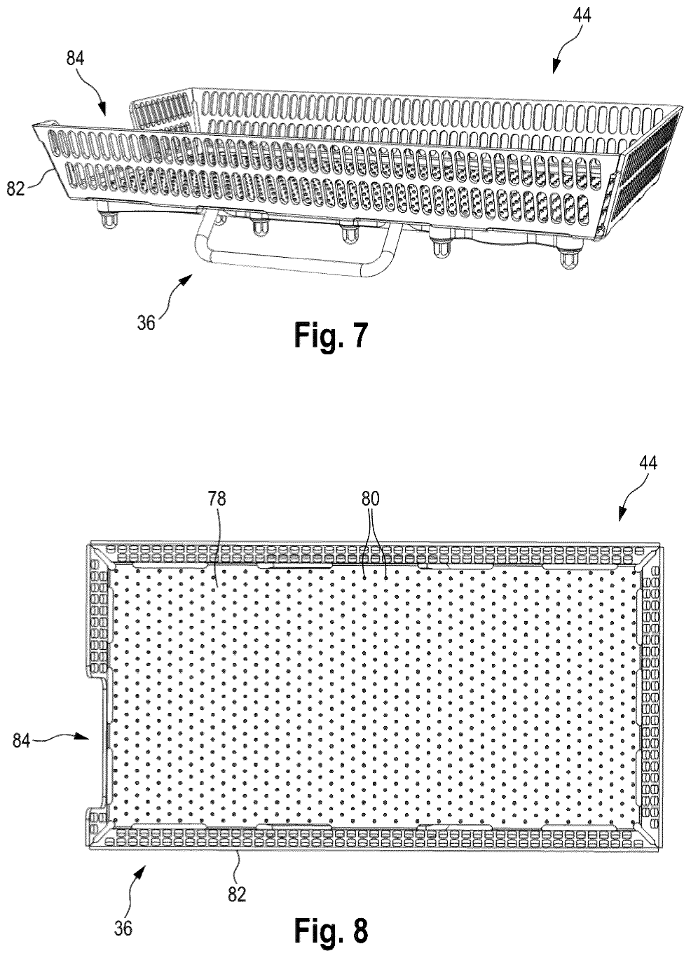

FIGS. 7 to 9 show the structure of the second vibrating plate 36, with the drive unit 40 omitted for better illustration of the plate.

The second vibrating plate 36 comprises (in particular on an upper side of the plate 44) a second surface 78 as a support for the closure elements. The closure elements can in particular be conveyed from the first vibrating plate 34 onto the second surface 78 and be arranged in the defined position on the second surface 78. The second surface 78 comprises knobs 80. The knobs 80 are evenly distributed over the surface 78. The knobs 80 project upward in the vertical direction from the second surface 78.

The second vibrating plate 36 (in particular the plate 44) comprises a peripheral edge. The second vibrating plate 36 comprises a barrier 82 on the peripheral edge. The barrier 82 extends along the peripheral edge and preferably completely encloses the second vibrating plate 36. The barrier 82 projects upward in the vertical direction from the second surface 66. The barrier 68 comprises an opening 84. The opening 84 is arranged on a side of the second vibrating plate 36 facing the first vibrating plate 34. In particular, the opening 84 is arranged flush with the first opening 74. Through the opening 74 and the opening 84, the closure elements can then be conveyed from the first vibrating plate 34 onto the second vibrating plate 36.

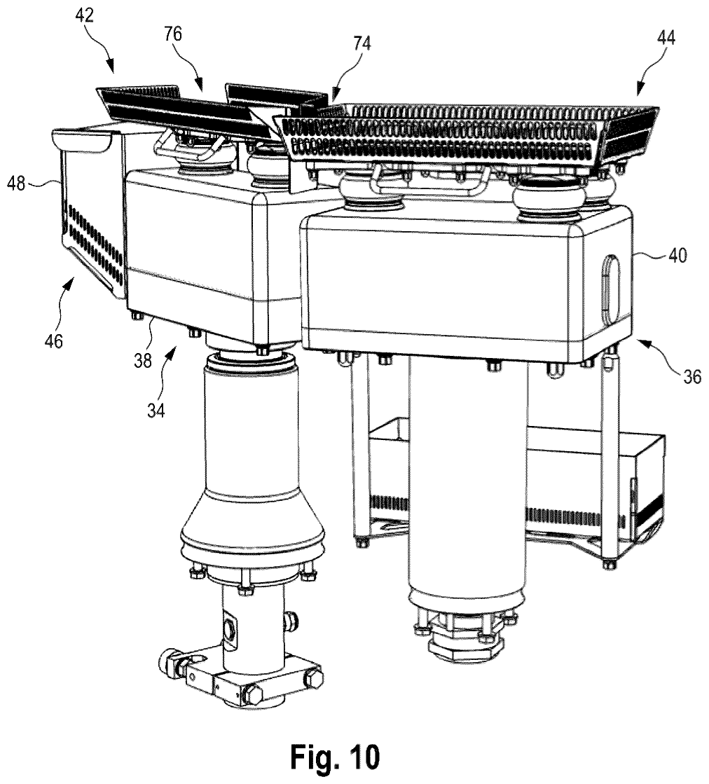

In FIG. 10, the arrangement of the first vibrating plate 34 relative to the second vibrating plate 36 and the discharge apparatus 46 is shown. The first vibrating plate 34 is arranged between the discharge apparatus 46 and the second vibrating plate 36. In particular, the collection container 48 and the second vibrating plate 36 are each arranged adjacent to the first vibrating plate 34. In particular, the plate 42 of the first vibrating plate 34 is arranged higher than the plate 44 of the second vibrating plate. Furthermore, the plate 42 of the first vibrating plate 34 is also arranged higher than the collection container 48.

During normal operation, the plate 42 of the first vibrating plate 34 is vibrated such that the closure elements are conveyed in the direction of the second vibrating plate 36 and, preferably a number of closure elements, through the first opening 74 onto the second vibrating plate 36. During special operation, the plate 42 of the first vibrating plate 34 is vibrated such that the closure elements are conveyed in the direction of the discharge apparatus 46 and through the second opening 76 into the collection container 48.

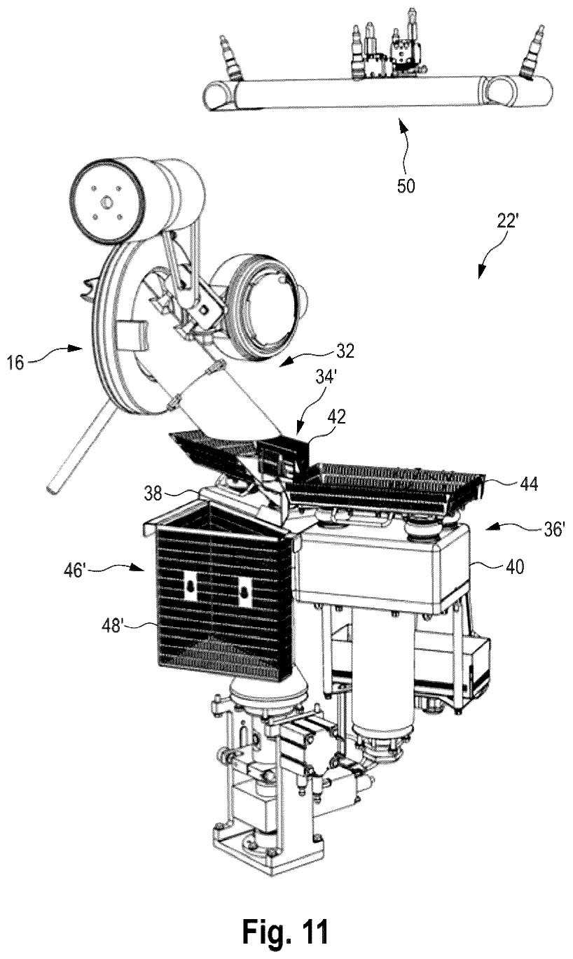

FIGS. 11 to 18 show a second embodiment of a feeding apparatus designated in its entirety with the reference numeral 22′. The feeding apparatus 22′ of the second embodiment essentially corresponds to the feeding apparatus 22 of the first embodiment from FIGS. 2 to 10. Identical elements are designated with the same reference numerals and are not explained in further detail. The feeding apparatus 22′ of the second embodiment differs from the feeding apparatus 22 of the first embodiment in the design of the first vibrating plate, the second vibrating plate, and the discharge apparatus. In particular, the feeding apparatus 22′ of the second embodiment differs from the feeding apparatus 22 of the first embodiment in the arrangement of the discharge apparatus. The first vibrating plate in the second embodiment is designated with the reference numeral 34′. The second vibrating plate in the second embodiment is designated with the reference numeral 36′. The discharge apparatus in the second embodiment is designated with the reference numeral 46′.

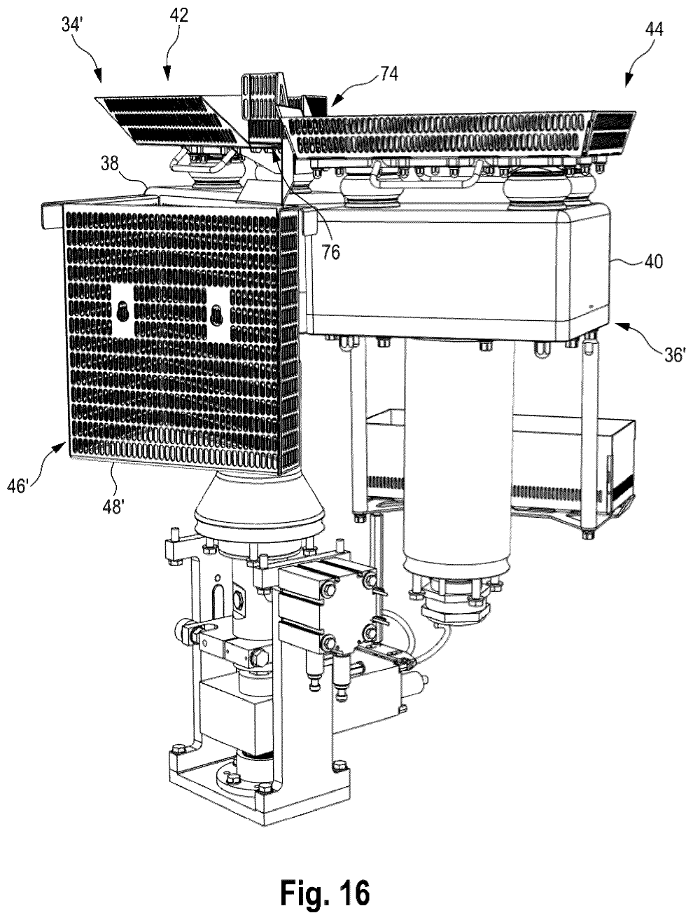

FIGS. 11 and 16 show that the discharge apparatus 46′ and the second vibrating plate 36′ are not arranged on opposite sides of the first vibrating plate 34′. Instead, the discharge apparatus 46′ and the second vibrating plate 36′ are arranged on two sides of the first vibrating plate 34′ that are adjacent to each other. The discharge apparatus 46′ and the second vibrating plate 36′ are arranged in a corner area of the first vibrating plate 34′, in particular adjacent to each other. As in the first embodiment, the discharge apparatus 46′ comprises a collection container 48′ for collecting closure elements.

The first vibrating plate 34′ essentially corresponds to the first vibrating plate 34 of the first embodiment from FIGS. 2 to 10. The first vibrating plate 34′ of the second embodiment differs from the first vibrating plate 34 of the first embodiment in the arrangement of the second opening 76.

The second vibrating plate 36′ essentially corresponds to the second vibrating plate 36 of the first embodiment from FIGS. 2 to 10. The second vibrating plate 36′ of the second embodiment differs from the second vibrating plate 36 of the first embodiment in the design of the barrier 82.

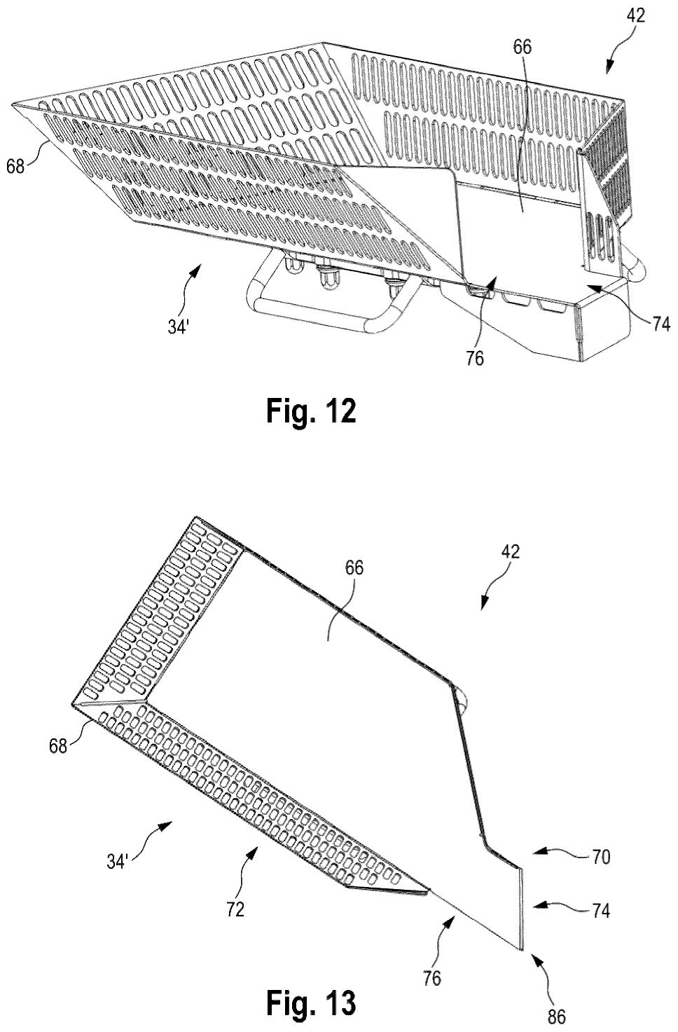

FIGS. 12 and 13 show the structure of the first vibrating plate 34′, with the drive unit 38 omitted for better illustration of the plate.

The second side 72 of the first vibrating plate 34′ is not arranged opposite the first side 70 in the second embodiment, but adjacent to the first side 70. The first opening 74 and the second opening 76 are arranged in an edge area 86. The edge area 86 is a corner area in which the first side 70 and the second side 72 are adjacent to each other. In particular, the first opening 74 and the second opening 76 are arranged adjacent to each other.

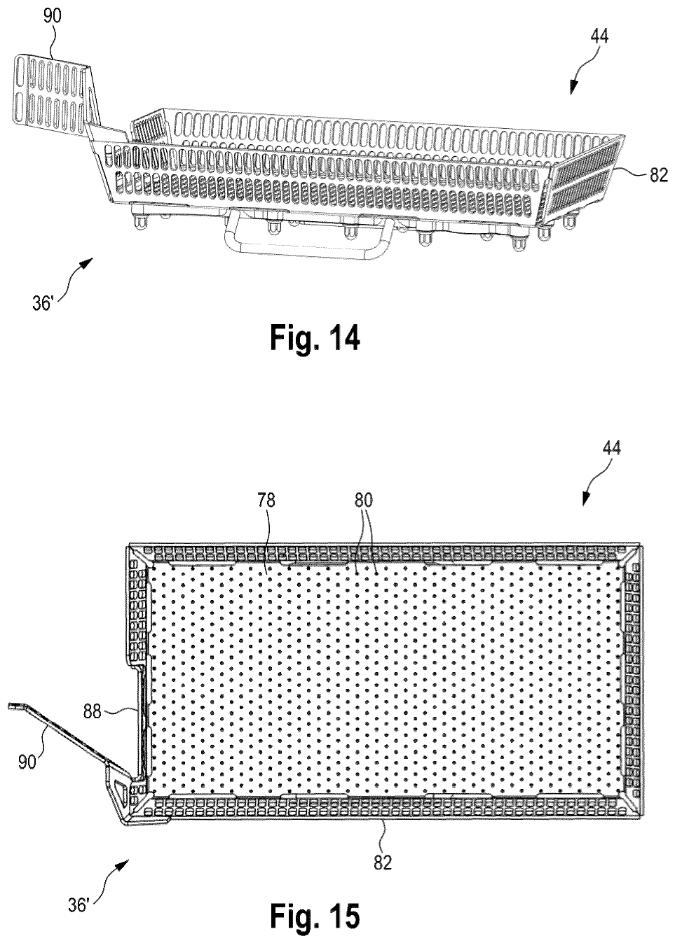

FIGS. 14 and 15 show the structure of the second vibrating plate 36′, with the drive unit 40 omitted for better illustration of the plate.

In the second embodiment, the barrier 82 additionally comprises a first section 88 and a second section 90. The first section 88 and the second section 90 are arranged on the side of the second vibrating plate 36′ facing the first vibrating plate 34′. The first section 88 extends in the region of the opening 84 along the peripheral edge of the second vibrating plate 36′. The second section 90 projects from the peripheral edge toward the first vibrating plate 34′. In particular, the two sections 88, 90 are arranged such that they extend along the edge area 86 of the first vibrating plate 36′, in particular adjoining it. The first section 88 is arranged in the area of the first opening 74. The second section is arranged in the area of the second opening 76.

FIG. 16 shows the arrangement of the first vibrating plate 34′ relative to the second vibrating plate 36′ and the discharge apparatus 46′. As described above, the discharge apparatus 46′ and the second vibrating plate 36′ are arranged on two sides of the first vibrating plate 34′ that are adjacent to each other. In particular, the two openings 74, 76 are arranged in the same edge area (corner area) 86 of the first vibrating plate 34′. The first conveying direction, in which the closure elements are conveyed during normal operation, and the second conveying direction, in which the closure elements are conveyed during special operation, are essentially parallel to each other in the second embodiment. In particular, the first plate 42 of the first vibrating plate 34′ can be vibrated during both normal and special operation such that the closure elements are conveyed in the direction of the edge area 86 and thus through either the first opening 74 or the second opening 76.

The first vibrating plate 34′ and the second vibrating plate 36′ additionally comprise a mechanism by which the first opening 74 can be opened during normal operation and closed during special operation, and the second opening 76 can be opened during special operation and closed during normal operation. This ensures that the closure elements are conveyed only onto the second vibrating plate 36′ during normal operation and only into the collection container 48′ during special operation.

This mechanism is illustratively shown in FIGS. 16 to 18. The first vibrating plate 34′ is movable in the vertical direction relative to the second vibrating plate 36′. In particular, the first and/or second drive unit 38, 40 can be configured to move the first plate 42 and/or the second plate 44 in the vertical direction. In particular, the first vibrating plate 34′ can be moved relative to the second vibrating plate 36′ in the vertical direction between a lowered position 92 and a raised position 94.

In particular, the first vibrating plate 34′ can be arranged in the raised position 94 during normal operation and in the lowered position 92 during special operation. In other words, the first vibrating plate 34′ can be lowered into the lowered position 92 during special operation and raised into the raised position 94 during normal operation. The control unit can be configured to control the first vibrating plate 34′ and/or the second vibrating plate 36′ during special operation in such a way that the first vibrating plate 34′ is lowered relative to the second vibrating plate 36′ into the lowered position 92. The control unit can further be configured to control the first vibrating plate 34′ and/or the second vibrating plate 36′ during normal operation in such a way that the first vibrating plate 34′ is raised relative to the second vibrating plate 36′ into the raised position 94.

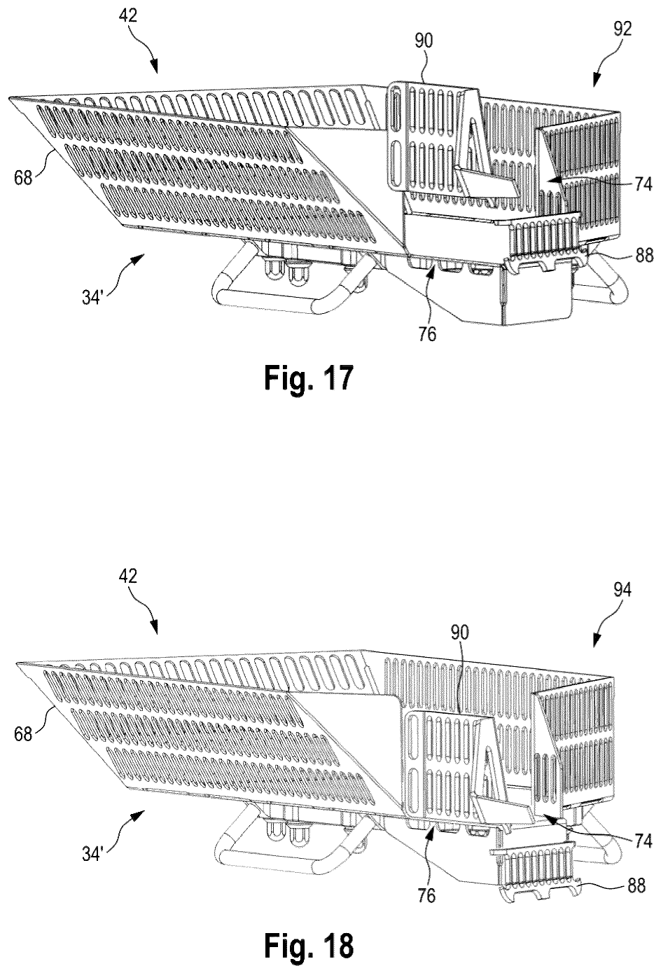

FIG. 17 shows the arrangement of the first section 88 and the second section 90 relative to the first vibrating plate 34 in the lowered position 92. In the lowered position 92, the first section 88 is arranged so that it closes the first opening 74. In the lowered position 92, the second section 90 is arranged so that it does not close the second opening 76. The first opening 74 is thus closed in the lowered position 92, so that closure elements cannot be conveyed through the first opening 74. The second opening 76 is accordingly open in the lowered position 92, so that closure elements can be conveyed through the second opening 76.

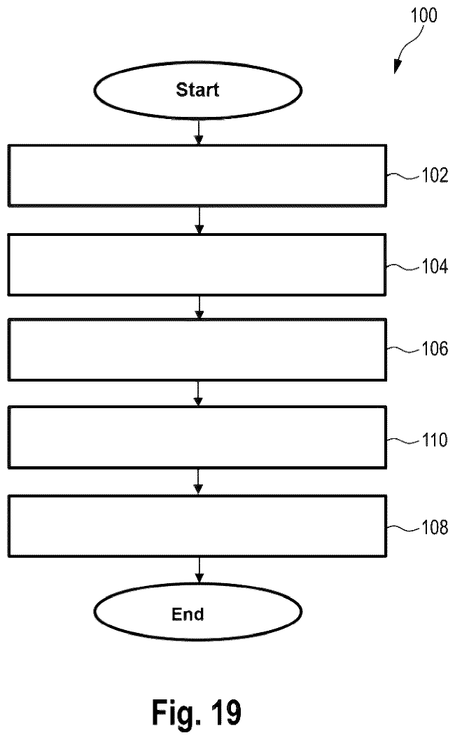

FIG. 18 shows the arrangement of the first section 88 and the second section 90 relative to the first vibrating plate 34 in the raised position 94. In the raised position 94, the first section 88 is arranged so that it does not close the first opening 74. In the raised position 94, the second section 90 is arranged so that it closes the second opening 76. The first opening 74 is thus open in the raised position 94, so that closure elements can be conveyed through the first opening 74. The second opening 76 is accordingly closed in the raised position 94, so that no closure elements can be conveyed through the second opening 76.

By arranging or lowering the first vibrating plate 34′ into the lowered position 92 during special operation, the closure elements are thus conveyed only into the collection container 48′. By arranging or raising the first vibrating plate 34′ into the raised position 94 during normal operation, the closure elements are thus conveyed only onto the second vibrating plate 36′.

FIG. 19 shows a first embodiment of a method for feeding closure elements into an environment with restricted access, in particular into the isolator 12. The method is designated in its entirety by reference numeral 100. The method 100 can be carried out in the isolator system 10. The method steps can be carried out, for example, using the feeding device 22, 22′ according to the first or second embodiment. In particular, in method 100, the feeding device 22, 22′ is arranged inside the environment with restricted access, in particular inside the isolator 12.

In a first step 102 of method 100, the closure elements are fed onto the first vibrating plate 34, 34′ by means of the feeding unit 32.

In a further step 104 of method 100, the closure elements, in particular during normal operation, are conveyed onto the second vibrating plate 36, 36′ by means of the first vibrating plate 34, 34′. During normal operation, the first vibrating plate is preferably arranged in the raised position 94.

In a further step 106 of method 100, the closure elements are arranged, in particular oriented, on the second vibrating plate 36, 36′ in a defined position by means of the second vibrating plate 36, 36′.

In a further optional step 108 of method 100, the closure elements, in particular during special operation, are conveyed to the discharge apparatus 46, 46′ by means of the first vibrating plate 34, 34′. In particular, the closure elements are conveyed into the collection container 48.

In a further optional step 110 of method 100, the first vibrating plate 34′ is lowered relative to the second vibrating plate 36′, in particular during special operation. Step 110 is performed prior to step 108. In particular, the first vibrating plate 34′ is lowered into the lowered position 92 during special operation. The lowering takes place in particular after the system switches from normal operation to special operation.

When the system switches from special operation back to normal operation, the first vibrating plate 34′ can be raised again into the raised position 94.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance, “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A feeding apparatus for feeding closure elements into an environment with restricted access, the feeding apparatus comprises a feeding unit, a first vibrating plate and a second vibrating plate, wherein the feeding unit is configured to feed the closure elements onto the first vibrating plate, the first vibrating plate is configured to convey the closure elements onto the second vibrating plate, and the second vibrating plate is configured to arrange the closure elements on the second vibrating plate in a defined position.

2. The feeding apparatus according to claim 1, wherein the feeding unit is coupleable to a port system in order to feed the closure elements.

3. The feeding apparatus according to claim 1, wherein the feeding unit comprises a chute or a tube, via which the closure elements can be fed onto the first vibrating plate.

4. The feeding apparatus according to claim 1, wherein the first vibrating plate comprises a first surface for conveying the closure elements, the closure elements can be fed onto the first surface and conveyed on the first surface, and the first surface is a flat surface.

5. The feeding apparatus according to claim 1, wherein the second vibrating plate comprises a second surface, the closure elements can be conveyed from the first vibrating plate onto the second surface and can be arranged on the second surface in the defined position, and the second surface comprises studs.

6. The feeding apparatus according to claim 1, wherein the feeding apparatus further comprises a control unit which is configured to control the first vibrating plate and the second vibrating plate.

7. The feeding apparatus according to claim 1, wherein the feeding apparatus further comprises a camera system which is configured to capture at least one image of the closure elements on the second vibrating plate, and the camera system and/or the control unit are configured to determine the position of the closure elements on the second vibrating plate on the basis of the at least one captured image.

8. The feeding apparatus according to claim 7, wherein the control unit is configured to control the second vibrating plate on the basis of the determined position of the closure elements such that at least one of the closure elements is arranged in the defined position.

9. The feeding apparatus according to claim 1, wherein the feeding apparatus further comprises a discharge apparatus for discharging closure elements.

10. The feeding apparatus according to claim 9, wherein the discharge apparatus comprises a collection container for collecting discharged closure elements.

11. The feeding apparatus according to claim 9, wherein at least one of the first vibrating plate or the second vibrating plate is configured to convey the closure elements to the discharge apparatus.

12. The feeding apparatus according to claim 9, wherein the second vibrating plate and the discharge apparatus are arranged on opposite sides of the first vibrating plate.

13. The feeding apparatus according to claim 9, wherein the second vibrating plate and the discharge apparatus are arranged on the same side of the first vibrating plate or at the same edge region of the first vibrating plate.

14. The feeding apparatus according to claim 1, wherein the first vibrating plate is movable relative to the second vibrating plate.

15. A barrier system, wherein the barrier system comprises an environment with restricted access and the feeding apparatus according to claim 1, the feeding apparatus is arranged within the environment with restricted access.

16. The barrier system according to claim 15, wherein the barrier system comprises a closing station for closing containers with the fed closure elements and a handling apparatus for transferring the closure elements from the second vibrating plate to the closing station.

17. A method for feeding closure elements into an environment with restricted access, wherein a feeding apparatus is arranged within the environment with restricted access, the feeding apparatus comprises a feeding unit, a first vibrating plate and a second vibrating plate, and the method comprises the steps of:
feeding the closure elements by means of the feeding unit onto the first vibrating plate;
conveying the closure elements by means of the first vibrating plate onto the second vibrating plate; and
arranging the closure elements by means of the second vibrating plate on the second vibrating plate in a defined position.

18. The method according to claim 17, wherein the feeding apparatus further comprises a discharge apparatus for discharging closure elements, wherein the method further comprises the step of:
conveying the closure elements by means of the first vibrating plate to a discharge apparatus.

19. The method according to claim 17, wherein the method further comprises the step of:
lowering the first vibrating plate relative to the second vibrating plate.
